(19) United States
(12) Patent Application Publication
(10) Pub. No.: US 2014/0090397 A1
(43) Pub. Date: Apr. 3, 2014

(54) BLEED TUBE ATTACHMENT

(71) Applicant: UNITED TECHNOLOGIES CORPORATION, Hartford, CT (US)

(72) Inventors: Brian C. Lund, Moodus, CT (US); Thomas W. Stowe, Hebron, CT (US); Christopher St. Mary, Hebron, CT (US)

(73) Assignee: UNITED TECHNOLOGIES CORPORATION, Hartford, CT (US)

(21) Appl. No.: 13/630,561

(22) Filed: Sep. 28, 2012

(51) Int. Cl. F02C 6/08; B23P 11/00

(52) U.S. Cl. 60/785; 29/888.02

(57) ABSTRACT

An anti-vortex assembly for a gas turbine engine includes a support ring including a seat surrounding an opening and a bleed tube including a base with a bearing face sealing against the seat. A retaining ring is mounted within the support ring and engages the base of the bleed air tube to hold the bleed tube within the support ring.

### BACKGROUND

A gas turbine engine typically includes a fan section, a compressor section, a combustor section and a turbine section. Air entering the compressor section is compressed and delivered into the combustion section where it is mixed with fuel and ignited to generate a high-speed exhaust gas flow. The high-speed exhaust gas flow expands through the turbine section to drive the compressor and the fan section. The compressor section typically includes low and high pressure compressors, and the turbine section includes low and high pressure turbines.

Cooling air is drawn from a cooler portion of the gas turbine engine such as the compressor section and provided to the hotter portions including the turbine section. In some instances, bleed air from the compressor section is drawn through bleed air tubes and directed to the turbine section. The bleed air tubes are supported for rotation with rotors in the compressor section. The bleed air tubes require support to prevent from being dislodged and require a seal to prevent significant leakage.

Accordingly, it is desirable to design and develop features to simplify assembly and reduce costs.

### SUMMARY

An anti-vortex assembly for a gas turbine engine according to an exemplary embodiment of this disclosure, among other possible things includes a support ring including a seat surrounding an opening, a bleed tube including a base including bearing face sealing against the seat and a tube extending through the opening, and a retaining ring mounted within the support ring and engaged to prevent rotation of the bleed tube within the opening.

In a further embodiment of the foregoing anti-vortex assembly, the support ring includes a lip supporting the bleed tube.

In a further embodiment of any of the foregoing anti-vortex assemblies, the lip defines an annular groove that receives the base.

In a further embodiment of any of the foregoing anti-vortex assemblies, the base includes a first side received within the support ring and a second side including a flat surface engaged against the retaining ring.

In a further embodiment of any of the foregoing anti-vortex assemblies, the seat includes a spherical inner diameter surrounding the opening.

In a further embodiment of any of the foregoing anti-vortex assemblies, the bearing face includes a spherical surface received on the seat.

In a further embodiment of any of the foregoing anti-vortex assemblies, the retaining ring includes first and second curled ends that wrap partially around the base of the bleed tube to prevent rotation relative to the support ring.

In a further embodiment of any of the foregoing anti-vortex assemblies, the retaining ring prevents rotation of the bleed tube assembly within the opening.

In a further embodiment of any of the foregoing anti-vortex assemblies, the support ring is a full annular structure mountable to a rotor.

A gas turbine engine according to an exemplary embodiment of this disclosure, among other possible things includes a compressor section disposed about an engine axis, a combustor in fluid communication with the compressor section, a turbine section in fluid communication with the combustor, and a bleed tube assembly mounted within the compressor section. The bleed tube assembly includes a support ring mounted to a rotor within the compressor section. A bleed tube includes a base having a bearing face seated on a seat disposed about an opening in the support ring and a retaining ring mounted within the support ring for preventing rotation of the base of the bleed tube.

In a further embodiment of the foregoing gas turbine engine, the support ring includes an annular lip defining an annular groove that receives the base.

In a further embodiment of any of the gas turbine engines, the base includes a first side received within the annular groove and a second side including a flat surface engaged against the retaining ring.

In a further embodiment of any of the gas turbine engines, the seat includes a spherical inner diameter surrounding the opening and the bearing face includes a spherical surface received on the seat.

In a further embodiment of any of the gas turbine engines, the retaining ring includes first and second curled ends that wrap partially around the base of the bleed tube to prevent rotation relative to the support ring.

A method of assembling a compressor section of a gas turbine engine according to an exemplary embodiment of this disclosure, among other possible things includes inserting at least one bleed tube within an opening of a support ring with a flat side of a base facing toward an annular groove defined in the support ring, rotating the bleed tube so that a second side opposite the first side is received within the annular groove, and inserting a retaining ring into the support ring against the flat side of the base to prevent rotation of the second side of the bleed tube.

In a further embodiment of the foregoing method, includes mounting a curved portion of the retaining ring against a surface of the at least one bleed tube.

In a further embodiment of any of the methods, includes seating a spherical bearing face of the bleed tube against a spherical inner diameter surrounding the opening.

In a further embodiment of any of the methods, includes mounting the support ring to a rotor of the compressor section.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a cross-section of an example gas turbine engine.

FIG. 2 is an enlarged portion of an example of a high pressure compressor of the example gas turbine engine.

FIG. 3 is a cross-section of an example anti-vortex assembly.

FIG. 4 is a perspective of the example anti-vortex assembly.

FIG. 5 is a partial sectional view of an example bleed tube.

FIG. 6 is a perspective view of an example support ring.

FIG. 7 is a cross-section view of the example support ring.

FIG. 8 is a perspective view of an example bleed tube.

FIG. 9 is a top view of the example bleed tube.

FIG. 10 is a bottom view of an example bleed tube supported within the support ring.

FIG. 11 is a perspective view of an example assembled anti-vortex assembly.

FIGS. 12A-C is a schematic representation of a method of installing and assembling the example anti-vortex assembly.

### DETAILED DESCRIPTION

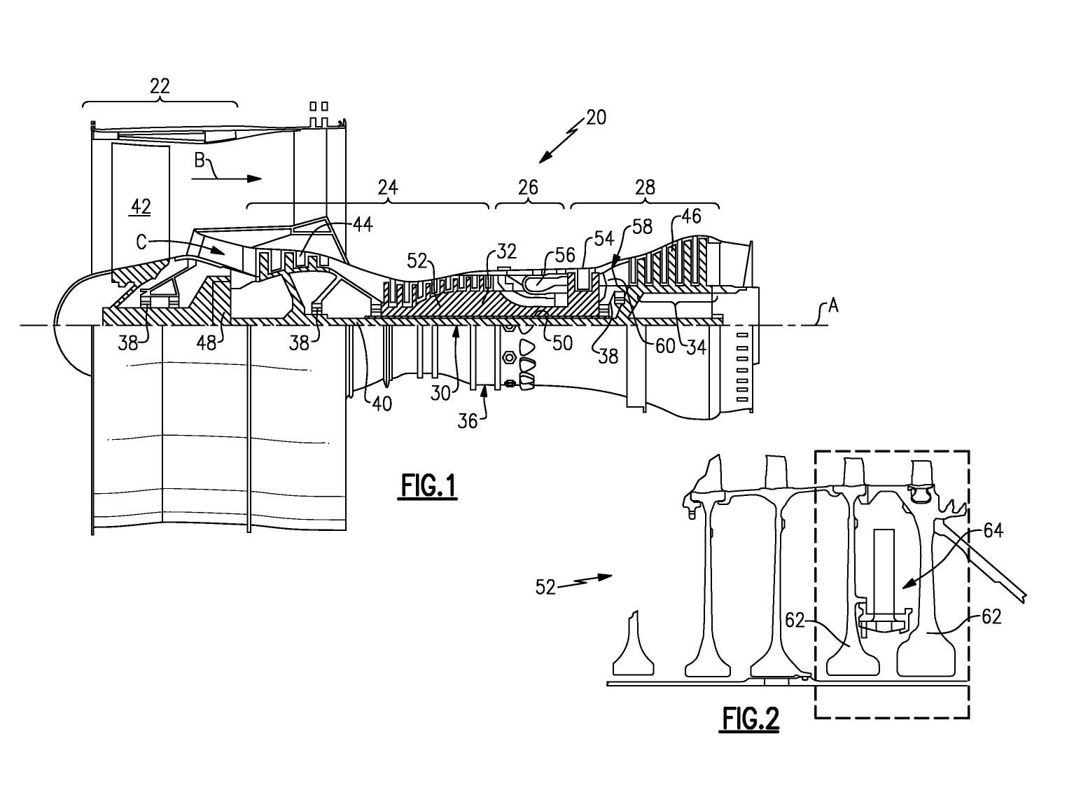

FIG. 1 schematically illustrates an example gas turbine engine 20 that includes a fan section 22, a compressor section 24, a combustor section 26 and a turbine section 28. Alternative engines might include an augmenter section (not shown) among other systems or features. The fan section 22 drives air along a bypass flow path B while the compressor section 24 draws air in along a core flow path C where air is compressed and communicated to a combustor section 26. In the combustor section 26, air is mixed with fuel and ignited to generate a high pressure exhaust gas stream that expands through the turbine section 28 where energy is extracted and utilized to drive the fan section 22 and the compressor section 24.

Although the disclosed non-limiting embodiment depicts a turbofan gas turbine engine, it should be understood that the concepts described herein are not limited to use with turbofans as the teachings may be applied to other types of turbine engines; for example a turbine engine including a three-spool architecture in which three spools concentrically rotate about a common axis and where a low spool enables a low pressure turbine to drive a fan via a gearbox, an intermediate spool that enables an intermediate pressure turbine to drive a first compressor of the compressor section, and a high spool that enables a high pressure turbine to drive a high pressure compressor of the compressor section.

The example engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided.

The low speed spool 30 generally includes an inner shaft 40 that connects a fan 42 and a low pressure (or first) compressor section 44 to a low pressure (or first) turbine section 46. The inner shaft 40 drives the fan 42 through a speed change device, such as a geared architecture 48, to drive the fan 42 at a lower speed than the low speed spool 30. The high-speed spool 32 includes an outer shaft 50 that interconnects a high pressure (or second) compressor section 52 and a high pressure (or second) turbine section 54. The inner shaft 40 and the outer shaft 50 are concentric and rotate via the bearing systems 38 about the engine central longitudinal axis A.

A combustor 56 is arranged between the high pressure compressor 52 and the high pressure turbine 54. In one example, the high pressure turbine 54 includes at least two stages to provide a double stage high pressure turbine 54. In another example, the high pressure turbine 54 includes only a single stage. As used herein, a “high pressure” compressor or turbine experiences a higher pressure than a corresponding “low pressure” compressor or turbine.

The example low pressure turbine 46 has a pressure ratio that is greater than about 5. The pressure ratio of the example low pressure turbine 46 is measured prior to an inlet of the low pressure turbine 46 as related to the pressure measured at the outlet of the low pressure turbine 46 prior to an exhaust nozzle.

A mid-turbine frame 58 of the engine static structure 36 is arranged generally between the high pressure turbine 54 and the low pressure turbine 46. The mid-turbine frame 58 further supports bearing systems 38 in the turbine section 28 as well as setting airflow entering the low pressure turbine 46.

Air flow through the core air flow path C is compressed by the low pressure compressor 44 then by the high pressure compressor 52 mixed with fuel and ignited in the combustor 56 to produce high speed exhaust gases that are then expanded through the high pressure turbine 54 and low pressure turbine 46. The mid-turbine frame 58 includes vanes 60, which are in the core airflow path and function as an inlet guide vane for the low pressure turbine 46. Utilizing the vane 60 of the mid-turbine frame 58 as the inlet guide vane for low pressure turbine 46 decreases the length of the low pressure turbine 46 without increasing the axial length of the mid-turbine frame 58. Reducing or eliminating the number of vanes in the low pressure turbine 46 shortens the axial length of the turbine section 28. Thus, the compactness of the gas turbine engine 20 is increased and a higher power density may be achieved.

The disclosed gas turbine engine 20 in one example is a high-bypass geared aircraft engine. In a further example, the gas turbine engine 20 includes a bypass ratio greater than about six (6), with an example embodiment being greater than about ten (10). The example geared architecture 48 is an epicyclical gear train, such as a planetary gear system, star gear system or other known gear system, with a gear reduction ratio of greater than about 2.3.

In one disclosed embodiment, the gas turbine engine 20 includes a bypass ratio greater than about ten (10:1) and the fan diameter is significantly larger than an outer diameter of the low pressure compressor 44. It should be understood, however, that the above parameters are only exemplary of one embodiment of a gas turbine engine including a geared architecture and that the present disclosure is applicable to other gas turbine engines.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft., with the engine at its best fuel consumption—also known as “bucket cruise Thrust Specific Fuel Consumption (‘TSFC’)”—is the industry standard parameter of pound-mass (lbm) of fuel per hour being burned divided by pound-force (lbf) of thrust the engine produces at that minimum point.

“Low fan pressure ratio” is the pressure ratio across the fan blade alone, without a Fan Exit Guide Vane (“FEGV”) system. The low fan pressure ratio as disclosed herein according to one non-limiting embodiment is less than about 1.50. In another non-limiting embodiment the low fan pressure ratio is less than about 1.45.

“Low corrected fan tip speed” is the actual fan tip speed in ft/sec divided by an industry standard temperature correction of [(Tram° R)/(518.7° R)]^{0.5}. The “Low corrected fan tip speed”, as disclosed herein according to one non-limiting embodiment, is less than about 1150 ft/second.

The example gas turbine engine includes the fan 42 that comprises in one non-limiting embodiment less than about 26 fan blades. In another non-limiting embodiment, the fan section 22 includes less than about 20 fan blades. Moreover, in one disclosed embodiment the low pressure turbine 46 includes no more than about 6 turbine rotors schematically indicated at 34. In another non-limiting example embodiment the low pressure turbine 46 includes about 3 turbine rotors. A ratio between the number of fan blades 42 and the number of low pressure turbine rotors is between about 3.3 and about 8.6. The example low pressure turbine 46 provides the driving power to rotate the fan section 22 and therefore the relationship between the number of turbine rotors 34 in the low pressure turbine 46 and the number of blades 42 in the fan section 22 disclose an example gas turbine engine 20 with increased power transfer efficiency.

Referring to FIG. 2, the example high pressure compressor 52 includes a plurality of rotors 62 that rotate about the axis A. An anti-vortex assembly 64 is disposed within the high pressure compressor section 52 to draw air from the compressor section 52 for use in other sections of the engine. For example, the anti-vortex assembly 64 draws air necessary for secondary flow and pressure within the turbine section 28 for cooling and other circumstances where cooler air is required.

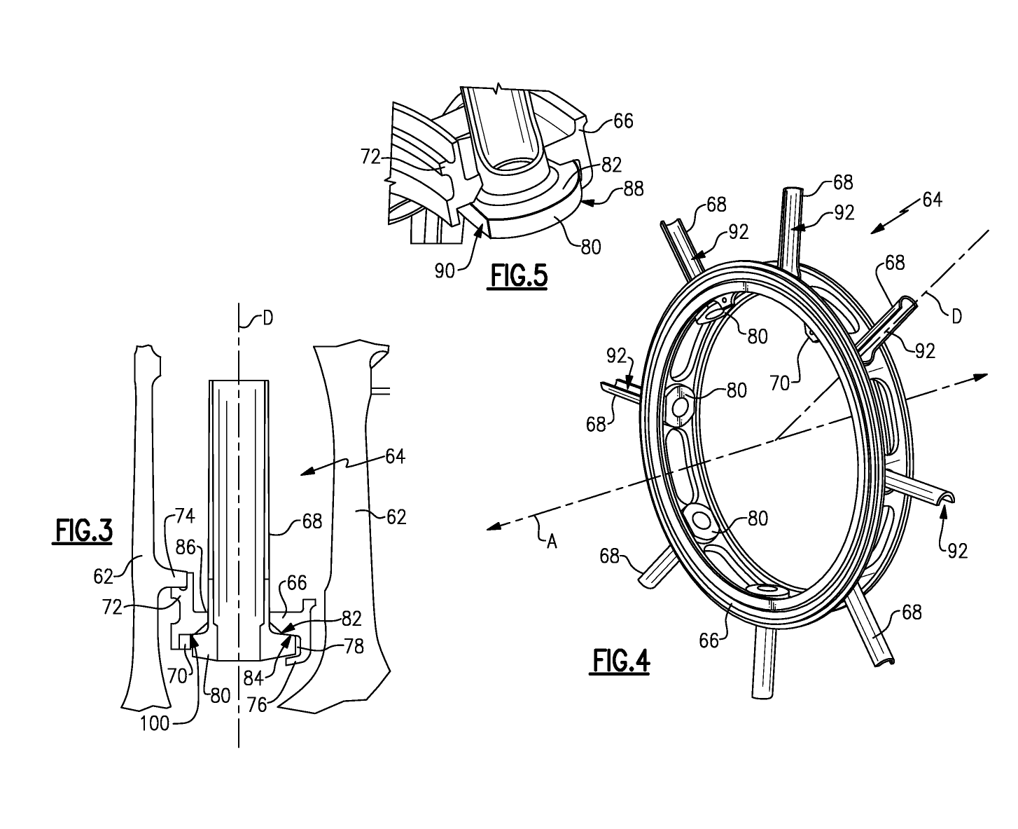

Referring to FIGS. 3, 4 and 5, the example anti-vortex assembly 64 includes a support ring 66 that is mounted to one of the rotors 62. The support ring 66 includes a press fit diameter 72 that mates with a boss portion 74 disposed on the rotor 62. The example support ring 66 is pressed onto the rotor 62 and specifically to the boss 74 such that it extends annularly about the axis A within the compressor section 52. The support ring 66 supports a bleed tube 68 along an axis D. The axis D is perpendicular to the engine axis A and extends radially outward as is illustrated in FIG. 4.

The bleed tube 68 includes a base 80 that fits and is supported on an inner diameter spherical seat 84 defined by the support ring 66. The base 80 includes a bearing face 82 that seats against the spherical seat 84. The base 80 includes a forward portion that fits within an annular groove 78 defined by a lip 76. The support ring 66 includes an opening 86 through which a portion of the bleed tube 68 extends.

The example anti-vortex assembly 64 includes a plurality of bleed tubes 68 that extend radial outward from the support ring 66. Each of the bleed tubes 68 include the base portion 80 that is fit within the groove 78 defined by the support ring 66. Each bleed tube 68 includes an open section 92 that aids in drawing air from the compressor section 52.

Each of the bleed tubes 68 are held within the support ring 66 by a retainer 70. The example retainer 70 is a split ring that snap fits within a groove 100 on an inner diameter of the support ring 66.

Referring to FIG. 5, the example bleed tube 68 includes the base 80 that includes the forward portion 88 that fits within the annular groove 78 and a flat portion 90 that is disposed on a side opposite the first portion 88. The flat portion 90 abuts against the retaining ring 70 to prevent rotation of the bleed air tube 68. Because the retaining ring 70 prevents rotation of the bleed air tube 60, it remains locked within the support ring 66 and specifically within the annular groove 78 defined by the lip 76.

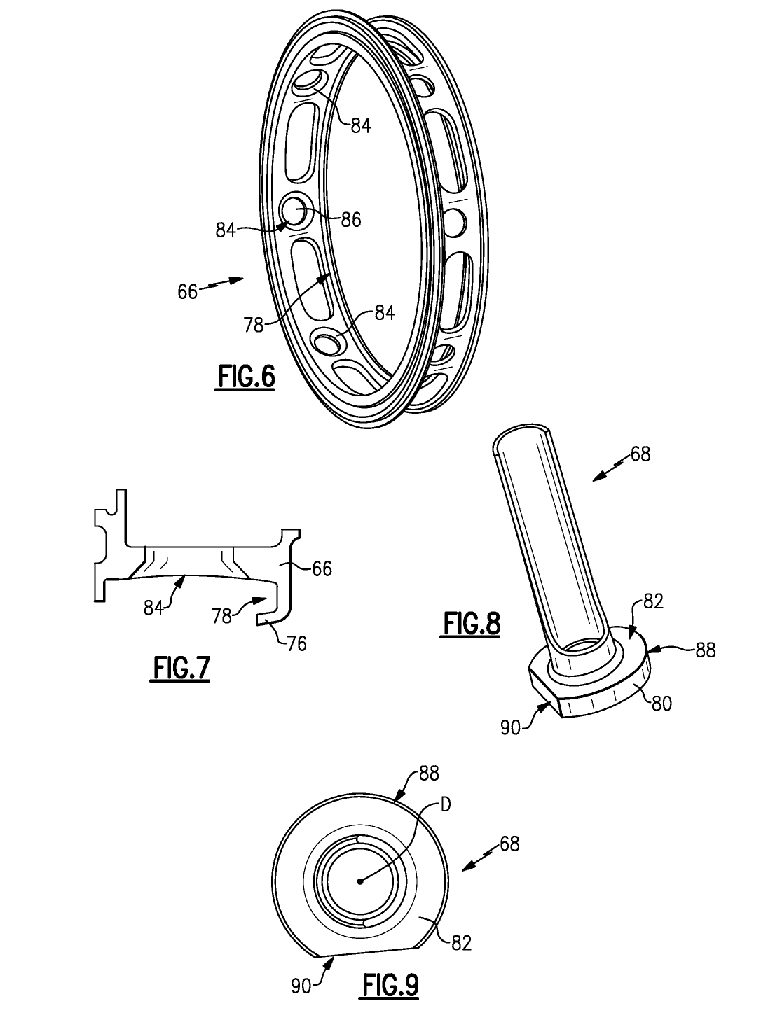

Referring to FIGS. 6 and 7, the example support ring 66 defines the opening 86 that receives a bleed air tube 68. Each of the openings 86 is surrounded by the inner diameter spherical seat 84. The spherical seat 84 provides for a sealing engagement with the bearing face 82 defined in the base 80 of the bleed air tube 68. The spherical mating surfaces between the base 80 and the spherical seat 84 provide a sealing engagement that is reinforced upon rotation of the support ring 66. As appreciated, rotation of the support rings 66 generates a centripetal force that forces the bearing face 82 against the seat 84 to provide the desired sealing contact.

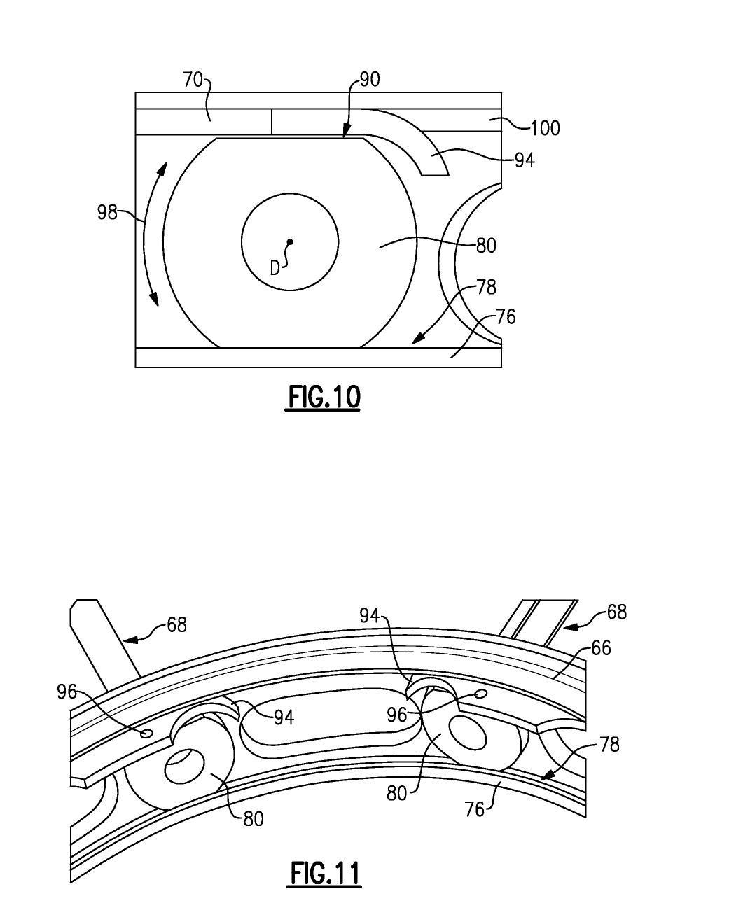

Referring to FIGS. 8 and 9, the example bleed air tube 68 includes the flat portion 90 that generates a substantially D-shaped outer periphery of the base portion 80. The flat portion 90 is engaged by the retaining ring 70 to prevent rotation and maintain the bleed air tubes 68 within the support ring 66.

Referring to FIGS. 10 and 11, the example retaining ring 70 includes curved ends 94 that wrap around a portion of the base 80 of a specific bleed air tube 68. The retaining ring 70 extends within the groove 100 defined within the support ring 66 and wraps partially around the base 80 of at least the bleed air tubes 68 that are disposed proximate the ends 94 of the retaining ring 70. Engagement between the flat portion 90 and retaining ring 70 prevents rotation of the bleed air tube 68 about the axis D in the direction indicated by arrows 98. The anti-rotation feature provided by the retaining ring 70 holds the base 80 within the groove 78 and therefore within the support ring 66.

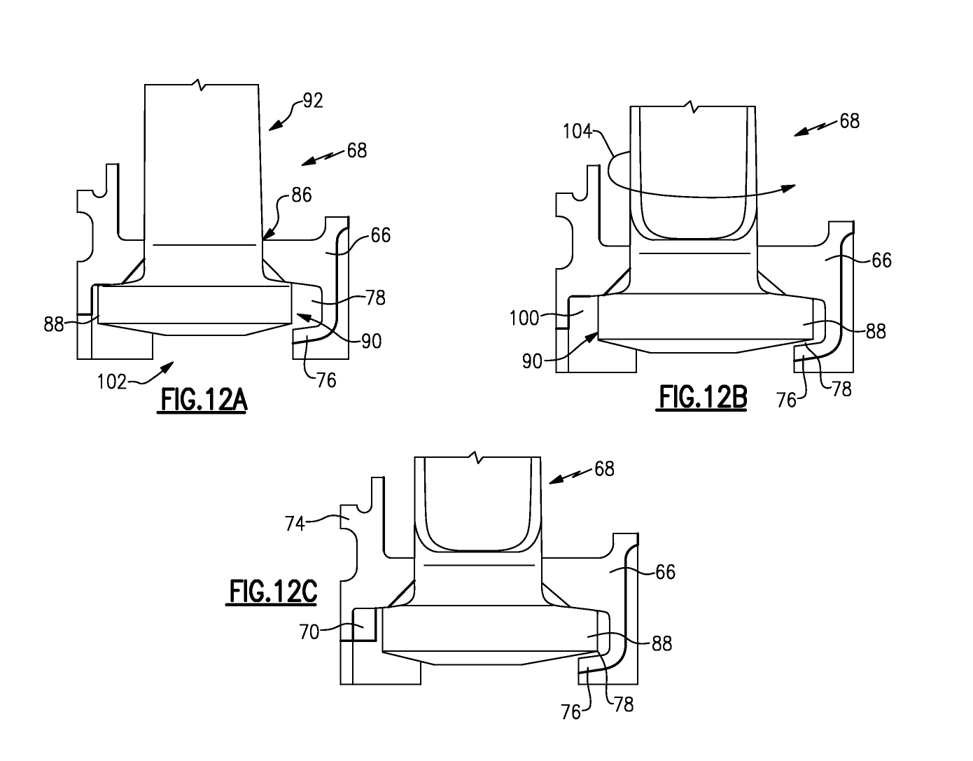

Referring to FIG. 12A, the example bleed air tube is assembled into the support ring 66 utilizing the non-symmetric features of the base 80. In this example, because the base 80 includes a substantially D-shaped outer periphery the bleed air tube 68 is initially inserted as is shown by arrow 102 within the opening 86 of the support ring 66. Before insertion of the bleed air tube 68 into the support ring 66, the flat portion 90 is aligned with the annular grooves 78 and the lip 76. Thee flat portion 90 aligns the bleed air tube 68 for insertion through the opening such that the bearing face 82 seats on the spherical seat 84.

Referring to FIG. 12B, once the bleed air tube 68 is fully seating against the spherical seat 84, it is rotated as is indicated at 104 such that the forward or first portion 88 is rotated to be received within the annular groove 78 defined by the lip 76. The rotation of the bleed air tube 68 aligns the flat portion 90 substantially perpendicular to the groove 100 defined within the support ring 66. As appreciated, rotation of the bleed air tube 68 provides for the assembly and mounting of the bleed air tube 68 without additional tools, fasteners, or other mating processes.

Referring to FIG. 12C, once the bleed air tube 68 is rotated such that the flat portion 90 is aligned with the groove 100 and the forward portion 88 is received within the groove 78 defined by the lip 76, the retainer 70 is inserted within the groove 100. The ends 94 (FIG. 10) of the retaining ring 70 wrap at least partially around the base 80 of the bleed air tube 68, to prevent rotation of the retaining ring 70 about the axis D (FIG. 3).

Referring to FIG. 10 with continued reference to FIG. 12C, the curved ends 94 prevent misalignment and mis-assembly of the retainer 70 into the support ring 66. The curved ends 94 cannot be assembled or fit within the groove 100 in an orientation other than that shown in FIG. 10. Accordingly, the retainer 70 includes features that prevent mis-assembly. Moreover, the example base 80 of the bleed air tube 68 is non-symmetric that further facilitates assembly without additional fastening members.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. An anti-vortex assembly for a gas turbine engine comprising:
a support ring including a seat surrounding an opening;
a bleed tube including a base including bearing face sealing against the seat and a tube extending through the opening; and
a retaining ring mounted within the support ring and engaged to prevent rotation of the bleed tube within the opening.

2. The anti-vortex assembly as recited in claim 1, wherein the support ring includes a lip supporting the bleed tube.

3. The anti-vortex assembly as recited in claim 1, wherein the lip defines an annular groove that receives the base.

4. The anti-vortex assembly as recited in claim 1, wherein the base includes a first side received within the support ring and a second side including a flat surface engaged against the retaining ring.

5. The anti-vortex assembly as recited in claim 1, wherein the seat comprises a spherical inner diameter surrounding the opening.

6. The anti-vortex assembly as recited in claim 5, wherein the bearing face comprises a spherical surface received on the seat.

7. The anti-vortex assembly as recited in claim 1, wherein the retaining ring includes first and second curled ends that wrap partially around the base of the bleed tube to prevent rotation relative to the support ring.

8. The anti-vortex assembly as recited in claim 7, wherein the retaining ring prevents rotation of the bleed tube assembly within the opening.

9. The anti-vortex assembly as recited in claim 1, wherein the support ring is a full annular structure mountable to a rotor.

10. A gas turbine engine comprising:
a compressor section disposed about an engine axis;
a combustor in fluid communication with the compressor section;
a turbine section in fluid communication with the combustor; and
a bleed tube assembly mounted within the compressor section, the bleed tube assembly including a support ring mounted to a rotor within the compressor section, a bleed tube including a base having a bearing face seated on a seat disposed about an opening in the support ring and a retaining ring mounted within the support ring for preventing rotation of the base of the bleed tube.

11. The gas turbine engine as recited in claim 10, wherein the support ring includes an annular lip defining an annular groove that receives the base.

12. The gas turbine engine as recited in claim 11, wherein the base includes a first side received within the annular groove and a second side including a flat surface engaged against the retaining ring.

13. The gas turbine engine as recited in claim 10, wherein the seat comprises a spherical inner diameter surrounding the opening and the bearing face comprises a spherical surface received on the seat.

14. The gas turbine engine as recited in claim 10, wherein the retaining ring includes first and second curled ends that wrap partially around the base of the bleed tube to prevent rotation relative to the support ring.

15. A method of assembling a compressor section of a gas turbine engine comprising:
inserting at least one bleed tube within an opening of a support ring with a flat side of a base facing toward an annular groove defined in the support ring;
rotating the bleed tube so that a second side opposite the first side is received within the annular groove; and
inserting a retaining ring into the support ring against the flat side of the base to prevent rotation of the second side of the bleed tube.

16. The method as recited in claim 15, including mounting a curved portion of the retaining ring against a surface of the at least one bleed tube.

17. The method as recited in claim 15, including seating a spherical bearing face of the bleed tube against a spherical inner diameter surrounding the opening.

18. The method as recited in claim 15, including mounting the support ring to a rotor of the compressor section.
